(19) United States
(12) Patent Application Publication
(10) Pub. No.: US 2010/0232721 A1
(43) Pub. Date: Sep. 16, 2010

(54) IMAGE COMPRESSION METHOD AND RELATED APPARATUS

(76) Inventors: Yi-Le Yang, Hsinchu City (TW); Chun-Liang Chen, Hsinchu City (TW); Yu-Cheng Lo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/463,435

(22) Filed: May 11, 2009

(30) Foreign Application Priority Data
Mar. 11, 2009 (TW) 098107875

(51) Int. Cl. G06K 9/36; H04B 1/66

(52) U.S. Cl. 382/239; 382/251; 375/240.03; 375/E07.126

(57) ABSTRACT

An image compression method includes: inputting an original image data and performing a specific transform operation upon the original image data to generate a transformed image data; performing a quantization operation upon the transformed image data according to a quantization table to generate a quantized image data; encoding the quantized image data to generate a compressed image data; and calculating a data amount corresponding to the compressed image data and accordingly determining whether to adjust the quantization table according to the data amount.

### BACKGROUND OF THE INVENTION

1. Field of the Invention

The present invention relates to image compression technology, and more particularly, to an image compression method and a related apparatus capable of dynamically adjusting a compression ratio in accordance with an amount of compressed data.

2. Description of the Prior Art

In daily life, people record a variety of video information. With the development of the Internet and electronic products, this video information can be easily conveyed; however, it is necessary to first process the information utilizing video compression technology due to the limitations of digital data transformation. Therefore, various video compression technologies are continually developed by researchers and engineers, of which. MJPEG (Motion Joint Picture Experts Group) technology is one of the earlier compression technologies and H.264 is the most recent. Each standard has different advantages and is suitable for different applications.

MJPEG technology is a kind of video compression with low complexity which is extended from a still image compression technology, Joint Photographic Experts Group (JPEG). Due to its characteristics and design, the compression ratio that can be provided is not very high. Thus, MJPEG is usually applied in devices that do not generate enormous raw data or do not need high compression quality; for example, digital cameras or web cameras. These devices do not have very high resolution, so the raw data and the data rate generated by these devices are not enormous. MJPEG technology is adequate for these devices.

In some applications, the above-mentioned video recording devices need to perform synchronous transmission for outputting the compressed video data, such as a web camera utilized for a video conference. However, most data transmission interfaces have limited bandwidths such as Universal Serial Bus (USB) 2.0 interface for 24 MB/s in synchronous transmission. Therefore, under the limitation of the bandwidth, if the data rate output by the video recording device is too large, an imperfection of the displaying video may occur at the receiving end. In the conventional art, the compression ratio is adjusted to get over the limitation of the bandwidth of synchronous transmission. Specifically, the conventional art determines whether to adjust the compression ratio by detecting the available volume of the buffer of the data transmission interface (e.g. Isochronous USB FIFO of USB interface).

In addition, during the MJPEG process, data corresponding to each video frame is firstly processed by a discrete cosine transform (DCT), and is then quantized and encoded. During the quantization operation, the coefficients generated in DCT operation are divided by the corresponding quantization values in the quantization table to decrease the precision of the coefficients, removing the high frequency component. In other words, the content of the quantization table will influence the compression ratio.

In the conventional art, when an Isochronous USB FIFO is full, it employs a quantization factor to adjust the quantization table to remove more components in the original video data, thereby increasing the compression ratio in order to decrease the data amount effectively. However, the conventional way of determining whether to adjust the compression ratio according to the available space of the buffer cannot properly respond to the following image data in a video sequence, thereby causing over compression of the still images (which do not need a high compression ratio). As a result, the image quality is sacrificed and the compression efficiency is worse.

### SUMMARY OF THE INVENTION

With this in mind, it is one objective of the present invention to solve the problem faced by the conventional art by dynamically adjusting the compression ratio in accordance with a difference amount between a limited bandwidth and a data amount of compressed image data of each video frame in a video sequence. Thus, the compressed ratio for a next video frame can be properly determined. More precisely, the present invention adjusts the quantization table (corresponding to the compression ratio) according to the variation of the data amount of the compressed image data, thereby deriving a better compressed image quality. As a result, the chosen compressed ratio can be more adaptive and over-compression can also be avoided.

To realize this concept, an image compression method and a related apparatus of the present invention introduce a process utilized for calculating the data amount of the compressed image data in order to make a reference for adjusting the quantization table. Each time an image data of a video frame is compressed, the process calculates the corresponding data amount. Then, determining whether to adjust the compression ratio can be accordingly executed based on the limited bandwidth and the data amount.

According to one exemplary embodiment of the present invention, an image compression method is provided. The image compression method comprises: inputting an original image data and performing a specific transform operation upon the original image data to generate a transformed image data; performing a quantization operation upon the transformed image data according to a quantization table to generate a quantized image data; encoding the quantized image data to generate a compressed image data; and calculating a data amount corresponding to the compressed image data and determining whether to adjust the quantization table according to the data amount.

According to another exemplary embodiment of the present invention, an image compression apparatus is provided. The image compression apparatus comprises: a transform unit, a quantization unit, an encode unit, a data amount calculation unit, and a quantization table update unit. The transform unit is utilized for receiving an original image data and performing a specific transform operation upon the original image data to generate a transformed image data. The quantization unit is coupled to the transform unit, and is utilized for performing a quantization operation upon the transformed image data according to a quantization table to generate a quantized image data. The encode unit is coupled to the quantization unit, and is utilized for encoding the quantized image data to generate a compressed image data. The data amount calculation unit is coupled to the encode unit, and utilized for calculating a data amount corresponding to the compressed image data and determining whether to adjust the quantization table according to the data amount. The quantization table update unit is coupled to the quantization unit and the data amount calculation unit, and is utilized for determining whether to adjust the quantization table according to the data amount calculated by the data amount calculation unit.

By the above image compression method and apparatus, the compression ratio for each image data can be dynamically adjusted so as to obtain a compressed image of high quality.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of an image compression method according to one exemplary embodiment of the present invention.

FIG. 2 is a flow chart of the operation of determining whether to adjust the compression ratio according to one exemplary embodiment of the present invention.

FIG. 3 is a diagram showing the relationship between the compression ratio and the data amount of the compressed image data.

FIG. 4 is a block diagram of an image compression apparatus according to one exemplary embodiment of the present invention.

### DETAILED DESCRIPTION

MPJEG technology will be taken as an example in the following. It should be noted that those skilled in the art will readily observe that numerous modifications and alterations of the apparatus and method (e.g. other image compression technology) may be made while retaining the teachings of the invention. Thus, these modifications and alterations based on the concept of the present invention should certainly fall within the scope of the present invention.

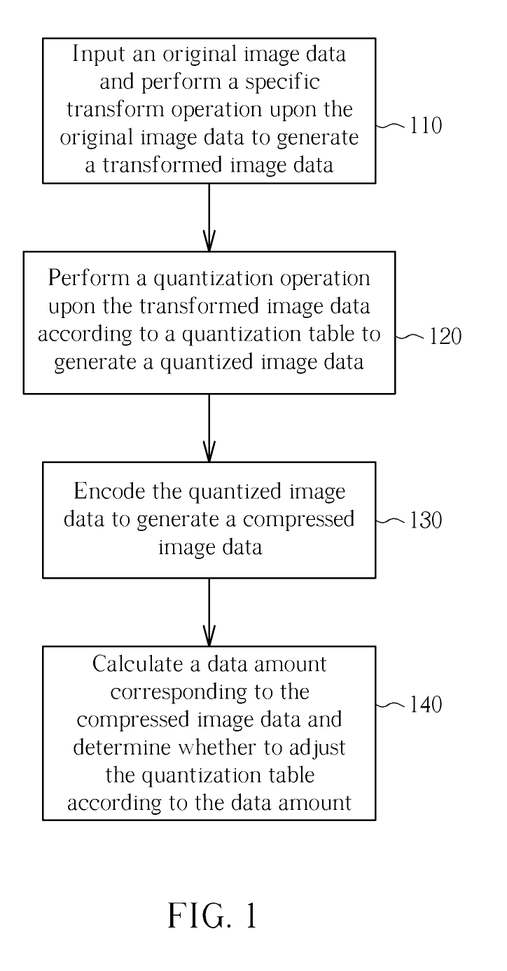

Please refer to FIG. 1, which depicts a flow chart of the image compression method according to one exemplary embodiment of the present invention. Steps 110-140 expressly illustrate each operation regarding the image compression method of the present invention. In step 110, the image compression method of the present invention performs a specific transform upon a currently input original image data in order to generate a transformed image data. For example, as far as MJPEG is concerned, the original image data includes YUV components regarding each pixel of one video frame, and the specific transform is a discrete cosine transform (DCT). However, this description of MJPEG technology is just for illustration, and is not meant to be a limitation of the present invention. In step 120, the image compression method continues to perform a quantization operation upon the transformed image data according to a quantization table in order to generate a quantized image data, wherein the transformed image data includes coefficients generated in the DCT operation. Via the quantization operation, these coefficients are divided by the corresponding quantization values in the quantization table to generate the quantized image data. The quantization table is defined in the MJPEG specification, so the related descriptions are omitted here for the sake of brevity. Accordingly, the quantized image data is encoded (e.g. entropy encoding) in step 130 to generate a compressed image data. When the compressed image data is generated, an essential operation of the present invention will be performed in step 140, which calculates a data amount corresponding to the compressed image data, and determines whether to adjust the quantization table on the basis of the data amount.

As the image compression of the present invention utilizes a data transmission interface to convey the compressed image data in a synchronous manner, the data amount will further be converted into data amount per second in order to compare with the bandwidth provided by the data transmission interface, which can further obtain a difference amount thereof. For instance, since the compressed image data corresponds to a video frame, a data rate of the compressed image data can be estimated according to the data amount of the compressed image data and number of frames per second (e.g. 30 frames/s) in the video sequence. By comparing the data rate with the limited bandwidth of the data transmission interface (e.g. the isochronous bandwidth 24 MB/s of USB 2.0), whether or not to adjust the quantization table can be determined. In another case, the limited bandwidth of the data transmission interface is converted into the data amount per frame (e.g. 24 MB/s÷30 frames/s=0.8 MB/frame) to obtain the average data amount per frame that the limited bandwidth can afford. Both these cases are alternative designs of the present invention.

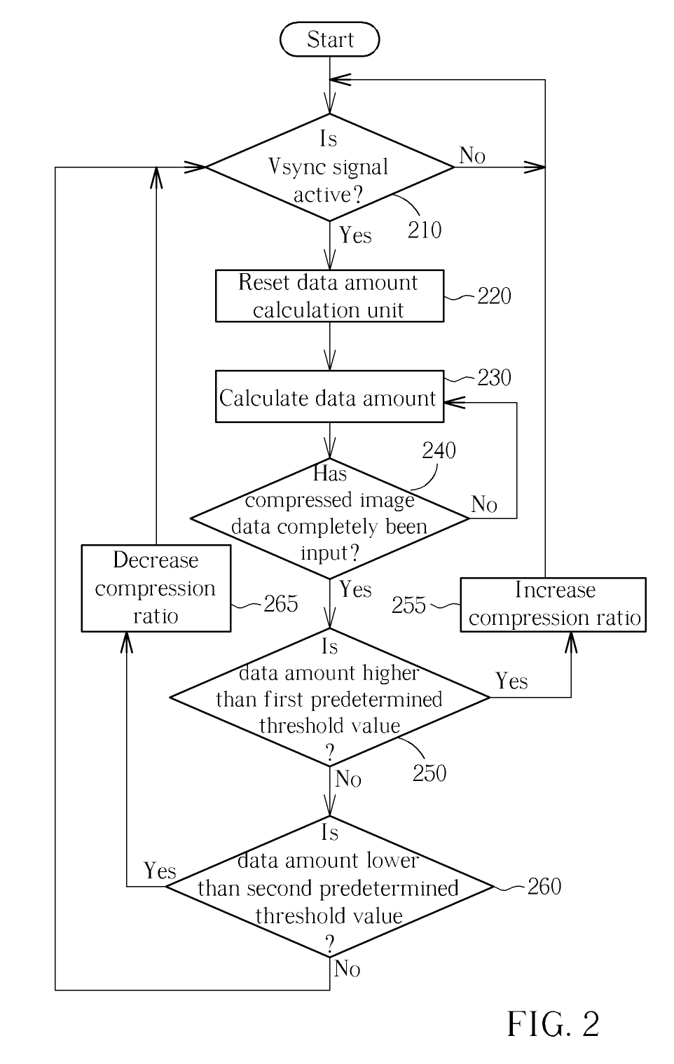

Please refer to FIG. 2, which depicts a flow chart of the operation that determines whether to adjust the quantization table according to one exemplary embodiment of the present invention. At first, the Vsync signal is checked to be active in step 210, wherein (as known by those skilled in the art) when the Vsync signal is active, it represents that the compressed image data of a following video frame will be input. In other words, if the Vsync signal is active, the operation that determines whether to adjust the quantization table will be activated. Then, in step 220, a calculation result of a previous data amount (which corresponds to the previous video frame) will be reset. A compressed image data amount corresponding to an inputting video frame begins to be calculated in step 230. Then, step 240 checks whether the compressed image data has completely been input. If the result is yes, step 250 is executed; if the result is no, the process goes to step 230, which continues to calculate the compressed image data amount until it has been completely received. In step 250, it is determined whether the data amount of the compressed image data is higher than a first predetermined threshold value. For example, the first predetermined threshold value could be a safe boundary which is slightly lower than the bandwidth limit. However, the first predetermined threshold value may change on the basis of practical requirements. If the data amount is higher than the first predetermined threshold value, it means that the quantization table used in the current quantization operation cannot provide a proper compression ratio, and the current data rate cannot fall within an ideal range. Thus, the present quantization table needs to be adjusted at this time to provide a higher compression ratio in order to make the data rate of the current compressed image data fall within the ideal range (in step 255). However, if the data amount is not higher than the predetermined threshold value, the process goes to step 260 where the data amount of the compressed image data is checked whether it is lower than a second predetermined threshold value (which is lower than the first predetermined threshold value). If the result is yes, it means that the current data rate of current compressed image data is much lower than the limitation of the bandwidth and step 265 is then executed to decrease the compression ratio, thereby making the following image data to be compressed have a higher image quality; if the result is no, it means that the data rate of the current compressed image data falls within an ideal range (between the first and second predetermined threshold values), and it is not necessary to adjust the quantization table in this embodiment.

It must be noted that, in other exemplary embodiments, it is also feasible that the quantization table is dynamically adjusted by only referencing one predetermined threshold value and the data amount of the compressed image data. That is, if the data amount of the compressed image data is higher than this predetermined threshold value (e.g. the first predetermined threshold value or the second predetermined threshold value), the compression ratio will increase; if the data amount is lower than this predetermined threshold value, the compression ratio will decrease. Such kind of adjustment can also achieve the objective of the present invention. Thus, the two different predetermined threshold values configured in FIG. 2 are meant to cause a hysteresis between two predetermined threshold values in order to decrease opportunities of quantization table adjustment, thereby alleviating the computing load of the compression apparatus. These two alternative designs are both derived from the spirit and concept of the present invention, and also fall within the scope of the present invention.

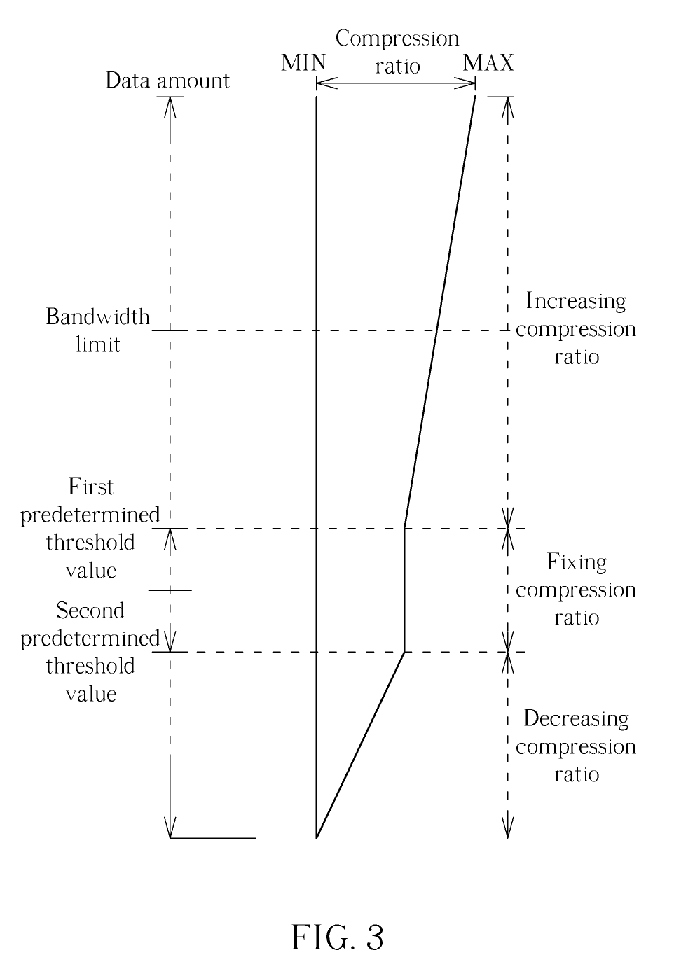

Moreover, one important concept is that the quantization table is adjusted according to a difference amount between the data amount and the predetermined threshold value in order to determine the change of the compression ratio. A relationship between the difference amount and the compression ratio will be explained with reference to FIG. 3. As shown in FIG. 3, when the data amount of the compressed image data is higher than a first predetermined threshold value, the compression ratio increases with the difference amount between the data amount and the first predetermined threshold value; similarly, when the data amount of the compressed image data is lower than a second predetermined threshold value, the compression ratio decreases with the difference amount between the data amount and the second predetermined threshold value. When the data amount of the compressed image data is between the first predetermined threshold value and the second predetermined threshold value, the compression ratio does not change. It should be particularly noted that the relationship between the compression ratio and the difference amount shown in FIG. 3 is just for explanatory purposes, and is not meant as a limitation. In other words, when the data amount is beyond the first predetermined threshold value, the compression ratio may increase in a different form from the linear monotonic increasing form as shown in FIG. 3. For example, when the data amount is higher than the first predetermined threshold value, the compression ratio initially increases in a specific form (e.g. a non-linear form). When the data amount exceeds the value corresponding to the limited bandwidth (e.g. 0.8 MB/frame) the compression ratio will increase in another form. Thus, in view of design choices, the adjustment of the quantization factor can be in a linear increasing/decreasing form or in a non-linear increasing/decreasing form. However, an important concept of the present invention is that the range of the compression ratio adjustment could vary with the data amount of the compressed image data, and there is no limitation in range or form of the compression ratio adjustment.

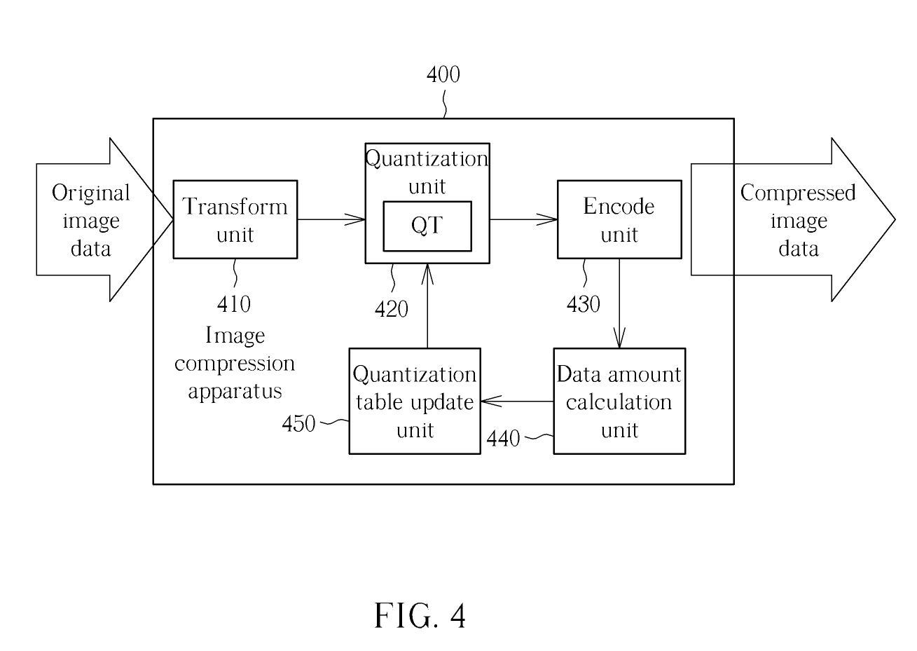

Based on the foregoing image compression method, a related image compression apparatus of the present invention is further provided. Please refer to FIG. 4, which illustrates a block diagram of an image compression apparatus according to one exemplary embodiment of the present invention. In this exemplary embodiment, an image compression apparatus 400 includes (but is not limited to): a transform unit 410, a quantization unit 420, an encode unit 430, a data amount calculation unit 440, and a quantization table update unit 450. Furthermore, the image compression apparatus 400 is designed according to the foregoing image compression method, so detailed description about the operations and concept regarding each unit is omitted here for the sake of brevity. Only a summary of each unit will be given in the following.

The transform unit 410 is employed for receiving an original image data and performing a specific transform operation upon the original image data to generate a transformed image data. As mentioned above, the transform unit 410 could perform a DCT operation. The quantization unit 420 is coupled to the transform unit 410, and employed for performing a quantization operation upon the transformed image data according to a quantization table QT to generate a quantized image data. The encode unit 430 is coupled to the quantization unit 420, and employed for encoding the quantized image data to generate a compressed image data. The data amount calculation unit 440 is coupled to the encode unit 430, and employed for calculating a data amount corresponding to the compressed image data. The quantization table update unit 450 is coupled to the quantization unit 420 and the data amount calculation unit 440. The quantization table update unit 450 is employed for determining whether to adjust the quantization table QT according to the data amount calculated by the data amount calculation unit 440. The method of determining whether to adjust the quantization table QT executed by the quantization table update unit 450 has already been illustrated expressly by FIG. 2 and FIG. 3, so the repeated descriptions are omitted here.

In conclusion, the spirit and concept of the present invention is to adaptively adjust the compression ratio according to the changes of the data amount of the compressed image data, thereby meeting both the compression efficiency and compressed image quality objectives. Moreover, the image compression apparatus of the present invention can be further combined with a data transmission interface (e.g. USB 2.0) to perform a synchronous video transmission.

Those skilled in the art will readily observe that numerous modifications and alterations of the device and method may be made while retaining the teachings of the invention.

What is claimed is:

1. An image compression method, comprising:
inputting an original image data and performing a specific transform operation upon the original image data to generate a transformed image data;
performing a quantization operation upon the transformed image data according to a quantization table to generate a quantized image data;
encoding the quantized image data to generate a compressed image data; and
calculating a data amount corresponding to the compressed image data and determining whether to adjust the quantization table according to the data amount.

2. The image compression method of claim 1, wherein the step of determining whether to adjust the quantization table according to the data amount comprises:
determining whether to adjust the quantization table according to a predetermined threshold value; and
adjusting the quantization table when the data amount is higher than the predetermined threshold value.

3. The image compression method of claim 2, wherein the step of adjusting the quantization table when the data amount is higher than the predetermined threshold value comprises:
determining a first quantization factor according to a difference amount between the data amount and the predetermined threshold value; and
utilizing the first quantization factor for adjusting the quantization table in order to update the quantization table.

4. The image compression method of claim 2, wherein the step of determining whether to adjust the quantization table according to the data amount further comprises:
determining whether to adjust the quantization table according to another predetermined threshold value, wherein the other predetermined threshold value is lower than the predetermined threshold value; and
adjusting the quantization table when the data amount is lower than the other predetermined threshold value.

5. The image compression method of claim 4, wherein the step of adjusting the quantization table when the data amount is lower than the other predetermined threshold value comprises:
determining a second quantization factor according to a difference amount between the data amount and the other predetermined threshold value; and
utilizing the second quantization factor for adjusting the quantization table in order to update the quantization table.

6. The image compression method of claim 4, wherein when the data amount is not higher than the predetermined threshold value and the data amount is not lower than the other predetermined threshold value, the quantization table is not adjusted.

7. The image compression method of claim 1, wherein the step of determining whether to adjust the quantization table according to the data amount comprises:
determining whether to adjust the quantization table according to a predetermined threshold value; and
adjusting the quantization table when the data amount is lower than the predetermined threshold value.

8. The image compression method of claim 7, wherein the step of adjusting the quantization table when the data amount is lower than the predetermined threshold value comprises:
determining a quantization factor according to a difference amount between the data amount and the predetermined threshold value; and
utilizing the quantization factor for adjusting the quantization table in order to update the quantization table.

9. The image compression method of claim 1, wherein the original image data corresponds to a video frame of a video sequence.

10. An image compression apparatus, comprising:
a transform unit, for receiving an original image data and performing a specific transform operation upon the original image data to generate a transformed image data;
a quantization unit, coupled to the transform unit, for performing a quantization operation upon the transformed image data according to a quantization table to generate a quantized image data;
an encode unit, coupled to the quantization unit, for encoding the quantized image data to generate a compressed image data;
a data amount calculation unit, coupled to the encode unit, for calculating a data amount corresponding to the compressed image data; and
a quantization table update unit, coupled to the quantization unit and the data amount calculation unit, for determining whether to adjust the quantization table according to the data amount calculated by the data amount calculation unit.

11. The image compression apparatus of claim 10, wherein the quantization table update unit determines whether to adjust the quantization table according to a predetermined threshold value, and the quantization table update unit determines to adjust the quantization table when the data amount is higher than the predetermined threshold value.

12. The image compression apparatus of claim 11, wherein when the data amount is higher than the predetermined threshold value, the quantization table update unit determines a first quantization factor according to a difference amount between the data amount and the predetermined threshold value, and utilizes the first quantization factor for adjusting the quantization table in order to update the quantization table.

13. The image compression method of claim 11, wherein the quantization table update unit further determines whether to adjust the quantization table according to another predetermined threshold value, and the other predetermined threshold value is lower than the predetermined threshold value, and when the data amount is lower than the predetermined threshold value, the quantization table update unit determines to adjust the quantization table.

14. The image compression apparatus of claim 13, wherein when the data amount is lower than the other predetermined threshold value, the quantization table update unit determines a second quantization factor according to a difference amount between the data amount and the other predetermined threshold value, and utilizes the second quantization factor for adjusting the quantization table in order to update the quantization table.

15. The image compression apparatus of claim 13, wherein when the data amount is not higher than the predetermined threshold value and the data amount is not lower than the other predetermined threshold value, the quantization table update unit determines not to update the quantization table.

16. The image compression apparatus of claim 10, wherein the quantization table update unit determines whether to adjust the quantization table according to a predetermined threshold value, and determines to adjust the quantization table when the data amount is lower than the predetermined threshold value.

17. The image compression apparatus of claim 16, wherein when the data amount is lower than the predetermined threshold value, the quantization table update unit determines a quantization factor according to a difference amount between the data amount and the predetermined threshold value, and utilizes the quantization factor for adjusting the quantization table in order to update the quantization table.

18. The image compression apparatus of claim 10, wherein the original image data corresponds to a video frame of a video sequence.
